(19) United States
(12) Patent Application Publication
(10) Pub. No.: US 2024/0088446 A1
(43) Pub. Date: Mar. 14, 2024

(54) NONAQUEOUS ELECTROLYTE SECONDARY BATTERY

(71) Applicant: Prime Planet Energy & Solutions, Inc., Tokyo (JP)

(72) Inventor: Yukitoshi UEHARA, Kobe-shi (JP)

(21) Appl. No.: 18/455,626

(22) Filed: Aug. 25, 2023

(30) Foreign Application Priority Data
Sep. 14, 2022 (JP) 2022-146424

(51) Int. Cl. H01M 10/0569; H01M 4/131; H01M 4/505; H01M 4/525; H01M 4/62

(52) U.S. Cl. CPC H01M 10/0569; H01M 4/131; H01M 4/505; H01M 4/525; H01M 4/625; H01M 2004/028; H01M 2220/20

(57) ABSTRACT

Provided is a nonaqueous electrolyte secondary battery having both high output characteristics and high capacity deterioration resistance in repetitive charge and discharge with a large current. A nonaqueous electrolyte secondary battery disclosed here includes a positive electrode, a negative electrode, and a nonaqueous electrolyte. The positive electrode includes a positive electrode current collector and a positive electrode active material layer supported by the positive electrode current collector. The positive electrode active material layer contains a positive electrode active material and carbon nanotubes. The nonaqueous electrolyte contains a nonaqueous solvent and a supporting electrolyte. The nonaqueous solvent contains 2 to 9 volume % of a carboxylate ester that has 6 or less carbon atoms and may be optionally substituted by a fluorine atom.

### TECHNICAL FIELD

The present disclosure relates to a nonaqueous electrolyte secondary battery. This application claims the benefit of priority to Japanese Patent Application No. 2022-146424 filed on Sep. 14, 2022. The entire contents of this application are hereby incorporated herein by reference.

### BACKGROUND ART

Recent nonaqueous electrolyte secondary batteries such as lithium ion secondary batteries are suitably used for, for example, portable power supplies for devices such as personal computers and portable terminals, and vehicle driving power supplies for vehicles such as battery electric vehicles (BEV), hybrid electric vehicles (HEV), and plug-in hybrid electric vehicles (PHEV).

With a rapidly increasing demand for HEVs, secondary batteries for drive power supplies for the HEVs are required to have further enhanced performance A positive electrode of a nonaqueous electrolyte secondary battery as a secondary battery for a drive power supply of an HEV generally employs a positive electrode active material and acetylene black as a conductive material. A nonaqueous electrolyte of the nonaqueous electrolyte secondary battery as a secondary battery for a drive power supply of an HEV generally employs carbonates as a nonaqueous solvent. On the other hand, it is known that carboxylate ester can be used as the nonaqueous solvent (see, for example, Patent Document 1).

### CITATION LIST

### Patent Document

Patent Document 1: JP2002-305035

### SUMMARY OF THE INVENTION

To enhance performance of a secondary battery for a drive power supply of an HEV, it is especially required to have a higher output and to enhance capacity deterioration resistance in repetitive charge and discharge with a large current. In particular, the HEV has a feature in which the secondary battery for the drive power supply is repeatedly charged and discharged in a narrow SOC range. However, an intensive study of the inventor of the present disclosure shows that a conventional nonaqueous electrolyte secondary battery insufficiently addresses the increasing demand for higher output and enhanced capacity deterioration resistance in repetitive charge and discharge with a large current.

It is therefore an object of the present disclosure to provide a nonaqueous electrolyte secondary battery that achieves high output characteristics and high capacity deterioration resistance in repetitive charge and discharge with a large current.

A nonaqueous electrolyte secondary battery disclosed here includes a positive electrode, a negative electrode, and a nonaqueous electrolyte. The positive electrode includes a positive electrode current collector and a positive electrode active material layer supported by the positive electrode current collector. The positive electrode active material layer contains a positive electrode active material and carbon nanotubes. The nonaqueous electrolyte includes a nonaqueous solvent and a supporting electrolyte. The nonaqueous solvent contains 2 to 9 volume % of a carboxylate ester that has 6 or less carbon atoms and may be optionally substituted by a fluorine atom.

This configuration can provide a nonaqueous electrolyte secondary battery that achieves high output characteristics and high capacity deterioration resistance in repetitive charge and discharge with a large current.

### BRIEF DESCRIPTION OF THE DRAWINGS

FIG. 1 is a cross-sectional view schematically illustrating an internal structure of a lithium ion secondary battery according to one embodiment of the present disclosure.

FIG. 2 is a schematic disassembled view illustrating a structure of a wound electrode body of a lithium ion secondary battery according to one embodiment of the present disclosure.

### DETAILED DESCRIPTION OF THE PREFERRED EMBODIMENTS

Embodiments of the present disclosure will be described hereinafter with reference to the drawings. Matters not specifically mentioned herein but required for carrying out the present disclosure can be understood as matters of design of a person skilled in the art based on related art in the field. The present disclosure can be carried out on the basis of the contents disclosed in the description and a common general technical knowledge in the field. In the drawings, members and parts having the same functions are denoted by the same reference characters for description. Dimensional relationships (e.g., length, width, and thickness) in the drawings do not reflect actual dimensional relationships. A numerical range expressed as “A to B” herein includes A and B.

A “secondary battery” herein refers to a power storage device capable of being repeatedly charged and discharged, and includes a so-called storage battery and a power storage element such as an electric double layer capacitor. A “lithium ion secondary battery” herein refers to a secondary battery that uses lithium ions as charge carriers and performs charge and discharge by movement of charges accompanying lithium ions between positive and negative electrodes.

The present disclosure will be described in detail hereinafter using a flat square lithium ion secondary battery including a flat wound electrode body and a flat battery case as an example, but the present disclosure is not intended to be limited to the embodiment.

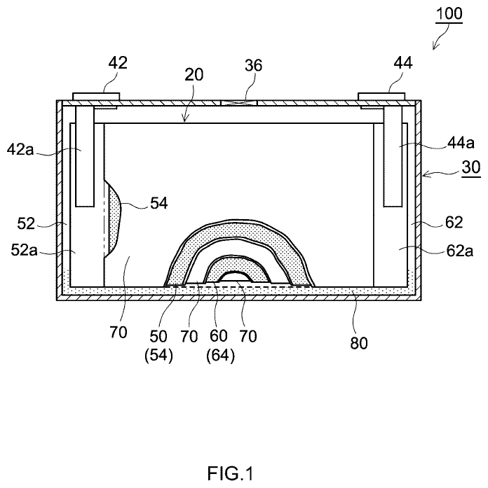

A lithium ion secondary battery 100 illustrated in FIG. 1 is a sealed battery in which a flat wound electrode body 20 and a nonaqueous electrolyte 80 are housed in a flat square battery case (i.e., an outer container) 30. The battery case 30 includes a positive electrode terminal 42 and a negative electrode terminal 44 for external connection, and a thin safety valve 36 configured such that when the internal pressure of the battery case 30 increases to a predetermined level or higher, the safety valve 36 releases the internal pressure. The battery case 30 has an injection port (not shown) for injecting the nonaqueous electrolyte 80. The positive electrode terminal 42 is electrically connected to a positive electrode current collector plate 42a. The negative electrode terminal 44 is electrically connected to a negative electrode current collector plate 44a. A material for the battery case 30 is, for example, a metal material that is lightweight and has high thermal conductivity, such as aluminium. FIG. 1 does not strictly illustrate the amount of the nonaqueous electrolyte 80.

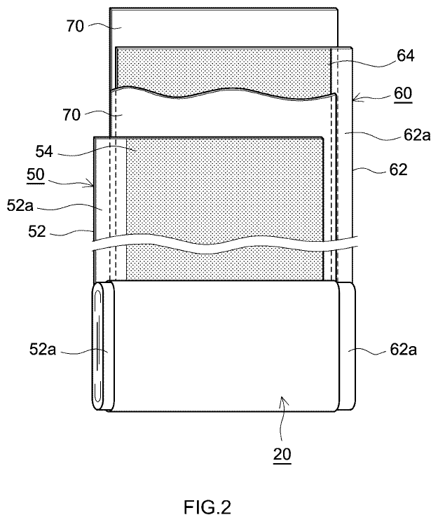

As illustrated in FIGS. 1 and 2, in the wound electrode body 20, a positive electrode sheet 50 and a negative electrode sheet 60 are stacked with two long separator sheets 70 interposed therebetween and are wound in the longitudinal direction. In the positive electrode sheet 50, a positive electrode active material layer 54 is formed on one or each (each in this example) surface of a long positive electrode current collector 52 along the longitudinal direction. In the negative electrode sheet 60, a negative electrode active material layer 64 is formed on one or each (each in this example) surface of a long negative electrode current collector 62 along the longitudinal direction. A positive electrode active material layer non-formed portion 52a (i.e., a portion where no positive electrode active material layer 54 is formed and the positive electrode current collector 52 is exposed) and a negative electrode active material layer non-formed portion 62a (i.e., a portion where no negative electrode active material layer 64 is formed and the negative electrode current collector 62 is exposed) extend off outward from both ends of the wound electrode body 20 in the winding axis direction (i.e., sheet width direction orthogonal to the longitudinal direction). The positive electrode current collector plate 42a and the negative electrode current collector plate 44a are respectively joined to the positive electrode active material layer non-formed portion 52a and the negative electrode active material layer non-formed portion 62a.

A ratio of the area of a principal surface of the negative electrode active material layer 64 to the area of a principal surface of the positive electrode active material layer 54 is desirably 1.05 to 1.15.

The positive electrode current collector 52 constituting the positive electrode sheet 50 may be a known positive electrode current collector for use in a lithium ion secondary battery, and examples of the positive electrode current collector 52 include sheets or foil of highly conductive metals (e.g., aluminium, nickel, titanium, and stainless steel). The positive electrode current collector 52 is desirably aluminium foil.

Dimensions of the positive electrode current collector 52 are not particularly limited, and may be appropriately determined depending on battery design. In the case of using aluminium foil as the positive electrode current collector 52, the thickness thereof is not particularly limited, and is, for example, 5 μm or more and 35 μm or less, desirably 7 μm or more and 20 μm or less.

The positive electrode active material layer 54 includes a positive electrode active material and carbon nanotubes (CNT). The positive electrode active material may be a known positive electrode active material to be used in a lithium ion secondary battery. Specifically, as the positive electrode active material, a lithium composite oxide or a lithium transition metal phosphate compound, for example, may be used. The crystal structure of the positive electrode active material is not specifically limited, and may be, for example, a layered structure, a spinel structure, or an olivine structure.

The lithium composite oxide is desirably a lithium transition metal composite oxide including at least one of Ni, Co, or Mn as a transition metal element, and specific examples of the lithium transition metal composite oxide include a lithium nickel composite oxide, a lithium cobalt composite oxide, a lithium manganese composite oxide, a lithium nickel manganese composite oxide, a lithium nickel cobalt manganese composite oxide, a lithium nickel cobalt aluminium composite oxide, and a lithium iron nickel manganese composite oxide.

It should be noted that the “lithium nickel cobalt manganese composite oxide” herein includes not only oxides including Li, Ni, Co, Mn, and O as constituent elements, but also oxides including one or more additive elements besides the foregoing elements. Examples of the additive elements include transition metal elements and typical metal elements, such as Mg, Ca, Al, Ti, V, Cr, Y, Zr, Nb, Mo, Hf, Ta, W, Na, Fe, Zn, and Sn. The additive element may be a metalloid element such as B, C, Si, or P, and a nonmetal element such as S, F, Cl, Br, or I. This also applies in the same manner to, for example, the lithium nickel composite oxide, the lithium cobalt composite oxide, the lithium manganese composite oxide, the lithium nickel manganese composite oxide, the lithium nickel cobalt aluminium composite oxide, and the lithium iron nickel manganese composite oxide.

Examples of the lithium transition metal phosphate compound include lithium iron phosphate (LiFePO₄), lithium manganese phosphate (LiMnPO₄), and lithium manganese iron phosphate.

These positive electrode active materials can be used alone or two or more of them may be used in combination. The positive electrode active material is particularly desirably the lithium nickel cobalt manganese composite oxide because of excellent characteristics such as an initial resistance characteristic.

An average particle size (median particle size: D50) of the positive electrode active material is not particularly limited, and is, for example, 0.05 μm or more and 25 μm or less, desirably 1 μm or more and 20 μm or less, and more desirably 3 μm or more and 15 μm or less. It should be noted that the average particle size (D50) of the positive electrode active material can be determined by, for example, a laser diffraction and scattering method.

A content of the positive electrode active material in the positive electrode active material layer 54 (i.e., content of the positive electrode active material with respect to the total mass of the positive electrode active material layer 54) is not specifically limited, and is, for example, 80 mass % or more, desirably 87 mass % or more, more desirably 90 mass % or more, even more desirably 95 mass % or more, and much more desirably 97 mass % or more.

In this embodiment, CNTs are used as a conductive material of the positive electrode active material layer 54. The CNTs are typically dispersed in the form of a single particle and/or an aggregate in the positive electrode active material layer 54 together with the positive electrode active material. The CNTs can enhance conductivity of the positive electrode active material layer 54, and increase output of the lithium ion secondary battery 100. In addition, in this embodiment, the CNTs are used in combination with a specific amount of a carboxylate ester. Due to this, output of the lithium ion secondary battery 100 can be further increased, and moreover, capacity deterioration resistance in repetitive charge and discharge of the lithium ion secondary battery 100 with a large current can be remarkably increased. This is supposed to be because of the following reasons.

A carboxylate ester having a small number of carbon atoms has the effect of reducing viscosity of the nonaqueous electrolyte 80. Here, the carboxylate ester having a small number of carbon atoms is used in combination with the CNTs as a conductive material of the positive electrode active material layer 54, and thereby wettability of the positive electrode active material layer 54 and the nonaqueous electrolyte 80 (i.e., ease of attachment of the nonaqueous electrolyte 80 to constituents of the positive electrode active material layer 54) can be enhanced. It is supposed that the followings contribute to this enhancement of wettability. The CNTs has a hollow cylindrical structure and the nonaqueous solvent such as the carboxylate ester also enters this hollow portion. Accordingly, the hollow portion also can be used for distribution of the nonaqueous electrolyte 80.

The enhancement of wettability of the positive electrode active material layer 54 and the nonaqueous electrolyte 80 can reduce output resistance. With this enhancement of wettability, uniformity of charging and discharging in charge/discharge cycles with a large current are enhanced and thereby, capacity deterioration in repetitive charge and discharge with a large current can be suppressed.

The type of the CNTs used is not particularly limited, and single-layer carbon nanotubes (SWCNTs), double-layer carbon nanotubes (DWCNTs), multilayer carbon nanotubes (MWCNTs), and so forth can be used. These nanotubes may be used alone or two or more types of them may be used in combination. The CNTs may be produced by a method such as an arc discharge method, a laser ablation method, or a chemical vapor deposition method. In general, MWCNTs have larger inner diameters than those of SWCNTs. Accordingly, since the nonaqueous electrolyte 80 can be more easily distributed in the hollow portion of the CNTs, MWCNTs are desirable as the CNTs.

An average length of the CNTs is not particularly limited. When the average length of the CNTs is excessively long, the CNTs are agglomerated, and dispersibility thereof tends to decrease. In addition, Li ions diffused in the CNTs are not easily released from the CNTs. For this reason, the average length of the CNTs is desirably 15 μm or less, more desirably 8.0 μm or less, and even more desirably 5.0 μm or less. On the other hand, when the average lengths of the CNTs is excessively short, the positive electrode active material surface is not easily covered with CNTs, and a conductive path between positive electrode active materials is less likely to be formed. For this reason, the average length of the CNTs is desirably 0.1 μm or more.

The average diameter of the CNTs is not particularly limited, and is, for example, 0.1 nm to 150 nm. Since the nonaqueous electrolyte 80 is easily distributed in the hollow portion of the CNTs, the average diameter of the CNTs is desirably 1.0 nm or more, and more desirably 2.0 nm or more. On the other hand, when the average diameter of the CNTs is excessively large, flexibility of particles of the CNTs decreases and thereby, the shape of the CNTs approach a rod shape, resulting in difficulty in covering the positive electrode active material with the CNTs. As a result, the degree of enhancement of wettability of the positive electrode active material surface might be small. In view of this, the average diameter of the CNTs is desirably 100 nm or less, and more desirably 50 nm or less.

The average length and the average diameter of the CNTs can be determined by taking an electron micrograph of the CNTs and calculating average values of lengths and diameters of 100 or more CNTs. Specifically, for example, a CNT dispersion is diluted and then dried, thereby preparing a measurement sample. This sample is observed with a scanning electron microscope (SEM), lengths and diameters of 100 or more CNTs are determined, and average values of the obtained lengths and the diameters are calculated. At this time, when CNTs are agglomerated again, a length and a diameter of the aggregate of the CNTs are determined.

Typically, only CNTs are used as a conductive material of the positive electrode active material layer 54. Alternatively, the positive electrode active material layer 54 may contain a conductive material (e.g., carbon black) other than CNTs within the range that does not significantly inhibit the effects of the present disclosure.

A content of CNTs in the positive electrode active material layer 54 is not particularly limited. When the content of the CNTs in the positive electrode active material layer 54 is excessively small, the effects described above might decrease. On the other hand, when the content of the CNTs is excessively large, events such as an increase in viscosity of the positive electrode slurry and a decrease in impregnating ability of the nonaqueous electrolyte 80 in the positive electrode active material layer 54 might occur in production of the lithium ion secondary battery 100. In view of this, the content of the CNTs in the positive electrode active material layer 54 is desirably 0.1 mass % or more and 3.0 mass % or less, more desirably 0.3 mass % or more and 2.5 mass % or less, even more desirably 0.5 mass % or more and 2.0 mass % or less.

The positive electrode active material layer 54 may include components other than the positive electrode active material, such as trilithium phosphate, a binder, and a carbon nanotube dispersant (CNT dispersant). Examples of the binder include polyvinylidene fluoride (PVdF).

Examples of the CNT dispersant include a surfactant-type dispersant (also called a low molecular dispersant), a polymeric dispersant, and an inorganic dispersant. The CNT dispersant may be anionic, cationic, amphoteric, or nonionic. Thus, the CNT dispersant may have, in the molecular structure thereof, at least one functional group selected from the group consisting of an anionic group, a cationic group, and a nonionic group. It should be noted that the surfactant refers to an amphiphilic substance with a chemical structure in which a hydrophilic part and a lipophilic part are included and are bound together by a covalent bond.

Specific examples of the CNT dispersant include: polycondensed aromatic surfactants such as a naphthalenesulfonic acid formalin condensate sodium salt, a naphthalenesulfonic acid formalin condensate ammonium salt, and a methyl naphthalenesulfonic acid formalin condensate sodium salt; polycarboxylic acid and a salt thereof such as polyacrylic acid and a salt thereof and polymethacrylic acid and a salt thereof; triazine derivative dispersants (desirably a dispersant including a carbazolyl group or a benzimidazolyl group); polyvinylpyrrolidone (PVP); polymers having a polynuclear aromatic group such as pyrene or anthracene in a side chain; and polynuclear aromatic ammonium derivatives such as a pyrene ammonium derivative (e.g., a compound in which an ammonium bromide group is introduced into pyrene) and an anthracene ammonium derivative. These CNT dispersants may be used alone or two or more of them may be used in combination. The CNT dispersant desirably includes a polynuclear aromatic group. Specifically, the CNT dispersant is desirably a polymer having a polynuclear aromatic group in a side chain, and a polynuclear aromatic ammonium derivative.

A content of trilithium phosphate in the positive electrode active material layer 54 is not particularly limited, and is desirably 1 mass % or more and 15 mass % or less, and more desirably 2 mass % or more and 12 mass % or less. A content of the binder in the positive electrode active material layer 54 is not particularly limited, and is desirably 0.1 mass % or more and 10 mass % or less, more desirably 0.2 mass % or more and 5 mass % or less, and even more desirably 0.3 mass % or more and 2 mass % or less.

A content of the CNT dispersant may be appropriately determined depending on types of the CNTs and the CNT dispersant. Here, when the proportion of the CNT dispersant is excessively small, dispersibility might be insufficient. On the other hand, when the proportion of the CNT dispersant is excessively large, the CNT dispersant excessively adheres to the CNT surface, thereby causing the possibility of a resistance increase. In a case where the CNTs are SWCNTs, the amount of use of the CNT dispersant is, for example, 1 part by mass to 400 parts by mass, desirably 20 parts by mass to 200 parts by mass, with respect to 100 parts by mass of the CNTs. In a case where the CNTs are MWNTs, the amount of use of the CNT dispersant is, for example, 1 part by mass to 100 parts by mass, desirably 4 parts by mass to 40 parts by mass, with respect to 100 parts by mass of the CNTs.

The thickness of the positive electrode active material layer 54 is not specifically limited, and is, for example, 10 μm or more and 300 μm or less, and desirably 20 μm or more and 200 μm or less.

The positive electrode sheet 50 may include an insulating layer (not shown) at the boundary between the positive electrode active material layer non-formed portion 52a and the positive electrode active material layer 54. The insulating layer may contain ceramic particles, for example.

As the negative electrode current collector 62 constituting the negative electrode sheet 60, a known negative electrode current collector for use in a lithium ion secondary battery may be used, and examples of the negative electrode current collector include sheets or foil of highly conductive metals (e.g., copper, nickel, titanium, and stainless steel). The negative electrode current collector 62 is desirably copper foil.

Dimensions of the negative electrode current collector 62 are not particularly limited, and may be appropriately determined depending on battery design. In the case of using copper foil as the negative electrode current collector 62, the thickness of the foil is not particularly limited, and is, for example, 5 μm or more and 35 μm or less, desirably 6 μm or more and 20 μm or less.

The negative electrode active material layer 64 includes a negative electrode active material. Examples of the negative electrode active material include carbon materials such as graphite, hard carbon, and soft carbon. Graphite may be natural graphite or artificial graphite, and may be amorphous carbon-coated graphite in which graphite is coated with an amorphous carbon material.

An average particle size (median particle size: DSO) of the negative electrode active material is not specifically limited, and is, for example, 0.1 μm or more and 50 μm or less, desirably 1 μm or more and 25 μm or less, and more desirably 5 μm or more and 20 μm or less. It should be noted that the average particle size (D50) of the negative electrode active material can be determined by, for example, a laser diffraction and scattering method.

The negative electrode active material layer 64 can include components other than the active material, such as a binder or a thickener. Examples of the binder include styrene-butadiene rubber (SBR) and polyvinylidene fluoride (PVdF). Examples of the thickener include carboxymethyl cellulose (CMC).

A content of the negative electrode active material in the negative electrode active material layer 64 is desirably 90 mass % or more, and more desirably 95 mass % or more and 99 mass % or less. A content of the binder in the negative electrode active material layer 64 is desirably 0.1 mass % or more and 8 mass % or less, and more desirably 0.5 mass % or more and 3 mass % or less. A content of the thickener in the negative electrode active material layer 64 is desirably 0.3 mass % or more and 3 mass % or less, and more desirably 0.5 mass % or more and 2 mass % or less.

The thickness of the negative electrode active material layer 64 is not particularly limited, and is, for example, 10 μm or more and 400 μm or less, desirably 20 μm or more and 300 μm or less.

Examples of the separator 70 include a porous sheet (film) of a resin such as polyethylene (PE), polypropylene (PP), polyester, cellulose, and polyamide. The porous sheet may have a single-layer structure or a laminated structure of two or more layers (e.g., three-layer structure in which PP layers are stacked on both surfaces of a PE layer). A heat-resistance layer (HRL) containing, for example, ceramic particles may be provided on a surface of the separator 70.

The thickness of the separator 70 is not particularly limited, and is, for example, 5 μm or more and 50 μm or less, desirably 10 μm or more and 30 μm or less. An air permeability of the separator 70 obtained by a Gurley permeability test is not particularly limited, and is desirably 350 sec./100 cc or less.

The nonaqueous electrolyte 80 includes a nonaqueous solvent and a supporting electrolyte. In this embodiment, the nonaqueous solvent contains a predetermined amount of a carboxylate ester that has 6 or less carbon atoms and may be optionally substituted by a fluorine atom.

The carboxylate ester having 6 or less carbon atoms has the effect of reducing the viscosity of the nonaqueous electrolyte 80. The combination of carboxylate ester having 6 or less carbon atoms and the CNTs as a conductive material of the positive electrode 50 described above can significantly increase output of the lithium ion secondary battery 100 and also significantly increase capacity deterioration resistance in repetitive charge and discharge of the lithium ion secondary battery 100 with a large current.

Examples of the carboxylate ester that has 6 or less carbon atoms and may be optionally substituted by a fluorine atom include: acetates such as methyl acetate, ethyl acetate, propyl acetate, butyl acetate, methyl difluoroacetate, ethyl trifluoroacetate, difluoromethyl acetate, trifluoromethyl acetate, and vinyl acetate; propionates such as methyl propionate, ethyl propionate, propyl acetate, and vinyl propionate; and butanoates such as methyl butanoate and ethyl butanoate.

Since the carboxylate ester easily enters the hollow portion of the CNTs, the number of the carbon atoms in the carboxylate ester is desirably four or less, and more desirably three or less. The carboxylate ester is desirably not substituted by a fluorine atom. The carboxylate ester is especially desirably methyl acetate.

When a content of the carboxylate ester in the nonaqueous solvent is excessively small, the effect of increasing output is insufficient. Thus, the content of the carboxylate ester in the nonaqueous solvent is 2 volume % or more, desirably 3 volume % or more, and more desirably 5 volume % or more. On the other hand, when the content of the carboxylate ester in the nonaqueous solvent is excessively large, the effect of increasing capacity deterioration resistance in repetitive charge and discharge of the lithium ion secondary battery 100 with a large current is insufficient. Thus, the content of the carboxylate ester in the nonaqueous solvent is 9 volume % or less, desirably 8.5 volume % or less, more desirably 8 volume % or less, and even more desirably 7 volume % or less.

The nonaqueous solvent includes an organic solvent other than carboxylate ester. Examples of the organic solvent include carbonates, ethers, nitriles, sulfones, and lactones, and among these organic solvents, carbonates are especially desirable. Examples of the carbonates include ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), and trifluorodimethyl carbonate (TFDMC). Such organic solvents may be used alone, or two or more of them may be used in combination.

The nonaqueous electrolyte 80 can contain a supporting electrolyte (i.e., electrolyte salt). Desired examples of the supporting electrolyte include lithium salts (desirably LiPF₆) such as LiPF₆, LiBF₄, and lithium bis(fluorosulfonyl)imide (LiFSI). A concentration of the supporting electrolyte is desirably 0.7 mol/L or more and 1.3 mol/L or less.

The nonaqueous electrolyte 80 may include components not described above, for example, various additives exemplified by: a film forming agent such as vinylene carbonate (VC) and an oxalato complex; a gas generating agent such as biphenyl (BP) or cyclohexylbenzene (CHB); and a thickener, to the extent that the effects of the present disclosure are not significantly impaired.

The lithium ion secondary battery 100 is excellent in both output characteristics and capacity deterioration resistance in repetitive charge and discharge with a large current. Thus, the lithium ion secondary battery 100 has high output and high durability. The lithium ion secondary battery 100 is applicable to various applications. Examples of desired applications include drive power supplies to be mounted on vehicles such as battery electric vehicles (BEVs), hybrid electric vehicles (HEVs), and plug-in hybrid electric vehicles (PHEVs). The lithium ion secondary battery 100 can be used as a storage battery for, for example, a small-size power storage device. Here, a drive power supply of an HEV is required to have both high output characteristics and high capacity deterioration resistance in repetitive charge and discharge with a large current. The lithium ion secondary battery 100 is especially excellent in capacity deterioration resistance in repetitive charge and discharge with a large current in a narrow SOC range. Thus, the lithium ion secondary battery 100 is especially desirably applicable to a drive power supply of an HEV. The lithium ion secondary battery 100 can be used in a form of battery pack in which a plurality of batteries are typically connected in series and/or in parallel.

The foregoing description is directed to the square lithium ion secondary battery 100 including the flat wound electrode body 20 as an example. Alternatively, the lithium ion secondary battery can also be configured as a lithium ion secondary battery including a stacked-type electrode body (i.e., electrode body in which a plurality of positive electrodes and a plurality of negative electrodes are alternately stacked). The lithium ion secondary battery can also be configured as a cylindrical lithium ion secondary battery or a laminated-case lithium ion secondary battery.

The secondary battery according to this embodiment can be configured as a nonaqueous secondary battery other than a lithium ion secondary battery according to a known method.

Examples of the present disclosure will now be described in detail, but are not intended to limit the present disclosure to these examples.

### Examples 1 to 4 and Comparative Example 1 to 5

First, LiNi_{1/3}Co_{1/3}Mn_{1/3}O₂ as a positive electrode active material, a conductive material, and a PVdF as a binder were mixed at a mass ratio of active material:conductive material:PVdF=97.5:1.5:1.0. As a conductive material, in Examples 1 to 4 and Comparative Examples 1 and 2, MWCNTs (average diameter: 15 nm, average length: 0.5 μm) were used. In Comparative Examples 3 to 5, acetylene black (AB; average particle size: 35 nm, average aggregate diameter: 1 μm) was used.

An appropriate amount of N-methyl-2-pyrrolidone was added to the mixture, thereby preparing positive electrode slurry. The positive electrode slurry was applied to each surface of aluminium foil with a thickness of 12 μm as a positive electrode current collector. At this time, as a lead connection portion, a positive electrode slurry uncoated portion was provided on the aluminium foil. The application amount of the positive electrode slurry was adjusted such that the weight per unit area of the resulting positive electrode active material layer is 11 mg/cm² in total at both surfaces.

The applied slurry was dried, thereby forming a positive electrode active material layer. The obtained sheet was pressed with rollers, and then adjusted such that the positive electrode active material layer had a porosity of 40 volume %. It should be noted that the porosity of the positive electrode active material layer was measured with a mercury porosimeter. The sheet was then cut into a predetermined size, thereby obtaining a positive electrode in which the positive electrode active material layer was formed on each surface of the positive electrode current collector.

Graphite as a carbon-based negative electrode active material, sodium salt of carboxymethyl cellulose (CMC-Na), and a dispersion of styrene-butadiene rubber (SBR) were mixed at a mass ratio of solid contents of graphite:CMC-Na:CMC=98:1:1. Ion-exchanged water was further added to this mixture, thereby preparing negative electrode slurry. The negative electrode slurry was applied to each surface of copper foil with a thickness of 8 μm as a negative electrode current collector. At this time, as a lead connection portion, a negative electrode slurry uncoated portion was provided on the copper foil.

The applied paste was dried, thereby forming a negative electrode active material layer. The obtained sheet was pressed with rollers, and then cut into a predetermined size, thereby obtaining a negative electrode in which the negative electrode active material layer was formed on each surface of the negative electrode current collector. The negative electrode active material layer had a packing density of 1.20 g/cm³.

A lead was attached to each of the positive and negative electrodes fabricated as described above. A single-layer polypropylene separator was prepared. Positive electrodes and negative electrodes were alternately stacked one by one with a separator interposed therebetween, thereby producing a stacked-type electrode body.

A mixed solvent including ethylene carbonate (EC), dimethyl carbonate (DMC), ethyl methyl carbonate (EMC), and methyl acetate at a volume ratio of 25:35:40-x: x was prepared (the value of x is shown in Table 1). Vinylene carbonate was dissolved in this mixed solvent at a concentration of 1 mass %, and lithium bis(oxalate)borate was dissolved at a concentration of 0.8 mass %, and LiPF₆ as a supporting electrolyte was dissolved at a concentration of 1.15 mol/L. In this manner, a nonaqueous electrolyte was obtained.

The thus-fabricated stacked-type electrode body and nonaqueous electrolyte were housed in a squared battery case and the squared battery case was sealed, thereby obtaining a square evaluation lithium ion secondary battery. It should be noted that the amount of injection of the nonaqueous electrolyte used was 9.0 g/Ah.

<Output Evaluation—Output Resistance Measurement>

Each evaluation lithium ion secondary battery was adjusted to have a state of charge (SOC) of 50% by constant current-constant voltage (CC-CV) charging, and then, placed in an environment of 25° C. Then, the secondary battery was discharged at a current value of 40 C for 10 seconds, and a voltage drop amount ΔV at this time was acquired. This voltage drop amount ΔV and the current value were used to calculate an output resistance of each evaluation secondary battery. Table 1 shows the results.

<High-Rate Cycle Characteristics Evaluation>

Each evaluation lithium ion secondary battery was placed in an environment of 25° C., and CC-CV charging with a charge voltage of 4.15 V at a charge current value of 0.5 C was performed for three hours. Thereafter, the secondary battery was discharged with a constant current (CC) to 2.5 V at a discharge current value of 0.5 C. A discharge capacity at this time was measured and defined as an initial capacity.

Then, each evaluation lithium ion secondary battery was placed in an environment of 75° C. The evaluation lithium ion secondary battery was charged to an SOC of 40%, and 25 cycles of repeated charging and discharging in which one cycle included constant-current charging with 12 C for one minute and constant-current discharging with 12 C for one minute were performed. Thereafter, the evaluation lithium ion secondary battery was discharged to an SOC of 0%.

An operation in which charging to an SOC of 40%, 25 cycles of the charging and discharging described above, and discharging to an SOC of 0% were preformed was repeated 400 times. Subsequently, in a manner similar to the initial capacity, a discharge capacity after charging-discharging cycle was measured. From (discharge capacity after charging-discharging cycle/initial capacity)×100, a capacity retention rate (%) was calculated. Table 1 shows the results.

[Table 1]

TABLE 1

| | Methyl | Conduc- | Output | Capacity |
|---|---|---|---|---|
| | acetate | tive | resis- | retention |
| | Proportion x | material | tance | rate |
| | (volume %) | Type | (mΩ) | (%) |
| Comparative Example 1 | 0 | MWCNT | 3.7 | 86.6 |
| Example 1 | 3 | MWCNT | 2.5 | 86.5 |
| Example 2 | 5 | MWCNT | 2.4 | 86.5 |
| Example 3 | 7 | MWCNT | 2.3 | 86.4 |
| Example 4 | 8 | MWCNT | 2.3 | 86.3 |
| Comparative Example 2 | 10 | MWCNT | 2.2 | 83.1 |
| Comparative Example 3 | 3 | AB | 4.0 | 82.6 |
| Comparative Example 4 | 5 | AB | 4.0 | 82.7 |
| Comparative Example 5 | 7 | AB | 3.9 | 82.7 |

As shown in the results of Table 1, in Examples 1 to 4 using CNTs as a conductive material of a positive electrode and methyl acetate as a nonaqueous solvent of a nonaqueous electrolyte in a range of 2 to 9 volume %, both low output resistance and high capacity after repetitive charge and discharge with a large current could be achieved. That is, in Examples 1 to 4, both high output characteristics and high capacity deterioration resistance in repetitive charge and discharge with a large current could be obtained.

In particular, Comparative Examples 3 to 5 are examples of conventional techniques using acetylene black typically used as a conductive material of a positive electrode of a nonaqueous electrolyte secondary battery. From a comparison of Comparative Examples 3 to 5 and Examples 1 to 4, it can be understood that the effect of increasing output characteristics and the effect of increasing capacity deterioration resistance in repetitive charge and discharge with a large current obtained in Examples 1 to 4 are significantly high. On the other hand, as shown in the results of Comparative Example 1, the use of only CNTs without methyl acetate insufficiently increased output characteristics.

### Examples 5 to 7 and Comparative Examples 6 to 10

Square evaluation lithium ion secondary batteries were obtained in the same manner as that described above except for using methyl propionate instead of methyl acetate of the nonaqueous solvent. The obtained evaluation lithium secondary batteries were subjected to output characteristic evaluation and high-rate cycle characteristic evaluation in the same manner as that described above. Table 2 shows results.

[Table 2]

TABLE 2

| | Methyl | Conduc- | Output | Capacity |
|---|---|---|---|---|
| | propionate | tive | resis- | retention |
| | Proportion x | material | tance | rate |
| | (volume %) | Type | (mΩ) | (%) |
| Comparative Example 6 | 0 | MWCNT | 3.7 | 86.6 |
| Example 5 | 3 | MWCNT | 2.7 | 86.6 |
| Example 6 | 5 | MWCNT | 2.7 | 86.5 |
| Example 7 | 7 | MWCNT | 2.6 | 86.4 |
| Comparative Example 7 | 10 | MWCNT | 2.6 | 83.5 |
| Comparative Example 8 | 3 | AB | 4.3 | 83.2 |
| Comparative Example 9 | 5 | AB | 4.3 | 83.1 |
| Comparative Example 10 | 7 | AB | 4.2 | 83.0 |

As shown in the results in Table 2, in the case of using methyl propionate instead of methyl acetate, similar results as those in Table 1 were obtained. This demonstrates that by a carboxylate ester having a small molecular size, the effect of increasing output characteristics and the effect of increasing capacity deterioration resistance in repetitive charge and discharge with a large current can be obtained. Thus, it can be understood that the nonaqueous electrolyte secondary battery disclosed here has both high output characteristics and high capacity deterioration resistance in repetitive charge and discharge with a large current.

Specific examples of the present disclosure have been described in detail hereinbefore, but are merely illustrative examples, and are not intended to limit the scope of claims. The techniques described in claims include various modifications and changes of the above exemplified specific examples.

That is, the nonaqueous electrolyte secondary battery disclosed here is described in items [1] to [5].

[1] A nonaqueous electrolyte secondary battery including:
a positive electrode;
a negative electrode; and
a nonaqueous electrolyte, wherein
the positive electrode includes a positive electrode current collector and a positive electrode active material layer supported by the positive electrode current collector,
the positive electrode active material layer contains a positive electrode active material and carbon nanotubes,
the nonaqueous electrolyte includes a nonaqueous solvent and a supporting electrolyte, and
the nonaqueous solvent contains 2 to 9 volume % of a carboxylate ester that has 6 or less carbon atoms and may be optionally substituted by a fluorine atom.

[2] The nonaqueous electrolyte secondary battery according to item [1] in which the carbon nanotubes are multilayer carbon nanotubes.

[3] The nonaqueous electrolyte secondary battery according to item [1] or [2] in which the carboxylate ester has 4 or less carbon atoms.

[4] The nonaqueous electrolyte secondary battery according to any one of items [1] to [3] in which the nonaqueous solvent contains 3 to 8 volume % of the carboxylate ester that has 6 or less carbon atoms and may be optionally substituted by a fluorine atom.

[5] The nonaqueous electrolyte secondary battery according to any one of items [1] to [4] in which the nonaqueous electrolyte secondary battery is a vehicle driving power supply of a hybrid electric vehicle.

What is claimed is:

1. A nonaqueous electrolyte secondary battery comprising:
a positive electrode;
a negative electrode; and
a nonaqueous electrolyte, wherein
the positive electrode includes a positive electrode current collector and a positive electrode active material layer supported by the positive electrode current collector,
the positive electrode active material layer contains a positive electrode active material and carbon nanotubes,
the nonaqueous electrolyte includes a nonaqueous solvent and a supporting electrolyte, and
the nonaqueous solvent contains 2 to 9 volume % of a carboxylate ester that has 6 or less carbon atoms and may be optionally substituted by a fluorine atom.

2. The nonaqueous electrolyte secondary battery according to claim 1, wherein the carbon nanotubes are multilayer carbon nanotubes.

3. The nonaqueous electrolyte secondary battery according to claim 1, wherein the carboxylate ester has 4 or less carbon atoms.

4. The nonaqueous electrolyte secondary battery according to claim 1, wherein the nonaqueous solvent contains 3 to 8 volume % of the carboxylate ester that has 6 or less carbon atoms and may be optionally substituted by a fluorine atom.

5. The nonaqueous electrolyte secondary battery according to claim 1, wherein the nonaqueous electrolyte secondary battery is a vehicle driving power supply of a hybrid electric vehicle.
